(19) United States
(12) Patent Application Publication
(10) Pub. No.: US 2025/0224051 A1
(43) Pub. Date: Jul. 10, 2025

(54) DUAL PIPING SYSTEM FOR THE DISTRIBUTION OF WATER AND OTHER FLUIDS

(71) Applicant: Hercules FERRARO, Lomas del Milador (AR)

(72) Inventor: Hercules FERRARO, Lomas del Milador (AR)

(21) Appl. No.: 18/846,792

(22) PCT Filed: Mar. 16, 2023
(86) PCT No.: PCT/IB2023/052573

§ 371 Date: Sep. 14, 2024

(30) Foreign Application Priority Data
Mar. 16, 2022 (AR) P20220100596

(51) Int. Cl. F16L 9/19; F16L 41/02; F16L 47/32

(52) U.S. Cl. CPC F16L 9/20; F16L 41/02; F16L 47/32

(57) ABSTRACT

DUAL piping system for the assembly/connection of a pair of pipes in tandem operating as a single pipe, by means of plumbed and secured maneuvers; suitable per se for the distribution of hot and cold water in buildings. Innovative dual design system (feasible and scalable in materials and joints regarded as benchmarks in the market) which, owing to its remarkable components, reduces current time and labor by 70%, by atomising (in bathrooms and kitchens) the already rudimentary dual-plumbing multi-connections to sanitary fixtures; and, in terms of productivity and aesthetics, it offers a natural optimal replacement.

### I. INTRODUCTION

The present Invention Patent refers to the DUAL Piping System, a Disruptive RESOLUTION for the Assembly/connection of a ‘Pair of pipes in Tandem’ operating as if it were only One; and this through ‘Plumbed and secured’ double-connected between its Exclusive components, in ‘Evolution and identity’ typical of this system . . . . Which constitute it in ‘New-MILESTONE’ for double Pipe laying.

Innovative and comprehensive system Suitable Per se for “Internal installations” for the distribution of “hot and cold” Water in buildings, which, enhanced with “Masterful DUAL design components”, generates a 70% Magna-reduction in Times and labors consumed when settling in; Resolving in this innovative Dual dynamic (in fierce contrast to the traditional ones until today) the ‘traumatic Zones’ of Multi-connected with cross-sections towards the sanitary fixtures in ‘Bathrooms, Kitchens and laundry rooms’, which currently employ individual ‘double-pipe’ runs in Quasi-parallel. And that in the same Dual design, it also solves the diverse options of Branching (with or without external connection), transport and distribution, etc.; just like that and as a result of its ‘Uniform Aesthetics’ it becomes attractive for Mounting on walls. All virtues that make it an optimal and natural replacement for said and today already Rudimentary double-laying.

The DUAL Piping System is also conceived ‘feasible and scalable’ in multiple Materials (plastic, metallic or mixed) with its Joints in standard format; and consequently, it can be interspersed between other pipes without limitations; as well as Expand to other benefits that said ‘Materials and joints’ allow

### II. BACKGROUND AND STATE OF THE ART

Regarding the Installations for Water distribution, we must ‘Conceptually and initially’ differentiate those of External supply networks, arranged in Roads and public spaces by ‘Public or private entities’; in contrast to the Internal water supply and distribution installations to the ‘Building Sanitary Fixtures’ that require this service, which we will refer to more and in general in this patent.

Although the external Networks (with the Roman Aqueducts as ‘1st. milestone’ in water conduction) accompany humanity with different tenor; the ‘Internal Installations’ on the contrary develop and spread with the ‘XX Century’, in tune with its general progress. And these begin as ‘Water taps’ within a few sumptuous buildings, but in a few decades, they expand to the general of the Buildings and their service environments (Bathrooms, Kitchens and Laundry rooms), and in ‘Increased comfort’ since its Devices (Bathtubs, Sinks, Washing Machines, etc.) require a double supply: ‘Cold and hot water’. In parallel to this expansion of the service, Materials for these pipes are developed: from the traditional Metallic to the Thermo-plastic (Rigid/flexible . . . Mono and multi-layer) or mixed, all in order to Optimize their health and useful life; those that also add ‘Union systems’ in pursuit of safer and/or simpler connections.

But at present and in clear Stagnation of the Technique (or Art) in its assembly, this ‘2ble supply of Water’ required today, is expressed worldwide through double Laying ‘in Quasi-parallel’ of independent pipes (in Ø≈½″) those that require ‘Artisanal and laborious Multi-connections’; and that also in its traumatic Zones of double-connection to the Sanitary devices (Gordian NODES s/‘FIG. 10a’) force the crossing of both pipes. Finished installations reflect ‘Complex and Rudimentary frameworks’ among their simple ‘Pipes and Fittings/accessories’. And this is the result of a biased industrialist Optics: it evolves ‘Only in materials and joints’, in clear Detriment of its Installation technicians; Given that these current Multi-connections must usually be carried out in reduced spaces, heights and awkward sectors, and in general in Intra-wall gutters where they end embedded.

Finally, and Clarification: It should be noted that regarding the Conduction of water (and other fluids) and even in external Networks, worldwide Uni-pipes continue today as the only alternative, they in various ‘Materials and joints’ and multiple Diameters . . . . However, and in only use of “cover pipes” for wiring (fiber optics, telephony, etc.), at present there are Multi-pipes (2 and more) in Unique format of ‘PE/HDPE Rolls in Ø 40 mm’; And that therefore DO NOT EXPRESS any precedent to the brand new ‘DUAL Piping System’ presented here.

### III. DETAILED DESCRIPTION OF THE INVENTION

Before manifesting the “Stagnation of the technique” (or Art) to the present, on the Assembly/connection of Installations for “double distribution” of Water (cold and hot- or other fluids) in the various buildings, the DUAL Piping System focuses to the ‘TECHNICIAN INSTALLER’ as REAL-CUSTOMER/User and his Productivity in these tasks, as owed Evolution (and NEW-Milestone) in these works; and from there ADDRESSES this ‘DUAL Resolution’ of Maximum relevance, since said works are usually located in the ‘final and more complex sections’ of the same, and in general in uncomfortable Sectors and/or in Intra-wall gutters.

The criteria of said DUAL-Resolution, in a technical/conceptual framework are:

Form an Unequivocal system of ‘Technical EVOLUTION’ focused on its Disruptive DUAL design′, suitable Per se for internal installations of distribution in Tandem of ‘hot and cold Water’ on the different buildings, and in that vein the ‘DUAL Piping System’ FACES and Resolves the Assembly/connection of a ‘Pair of pipes’ Operating as if it were only one, by means of ‘Plumbed and secured’ maneuvers. An Innovative dynamism resulting from this “Integral and innovative system” of Dual components (Fittings/accessories and Pipes) which, in their own Identity, are twinned by Group frameworks, that ensure sufficient Rigidity and calibrated Equidistance (between ducts) with Thermal imperturbability, all in guarantee of its exclusive ‘Plumb and Dual’ Inter-connectivity between parts; Latticed that until Normalized, will be at the criteria of the system manufacturer.

And all for the benefit of the Promptness and aesthetics of these works; given (i) ‘Reduce channeling and filling work’ if Intra-walls is installed on a traditional track; or in New maxim (ii) ‘Invites to be placed on the wall’ that requires a double-laying, be it for a ‘Fast and simple’ repair replacement of failed intra-wall installations (avoiding generalized breaks), as well as foreseen for New buildings and/or services.

That in the previously detailed and same Dual-operative provision, the DUAL Piping System ‘Untangles in its plane and Thickness’ the traumatic ‘Gordian NODES’ (Multi-connected for double-supply to the Sanitary devices/with or without between-crossings) generated in the current individual ‘Double-pipe sections’ in Quasi-parallel, by means of Magistral Dual-components designed for this purpose; that Atomize said connections to Only 2 or 3 Joints/assemblies maximum, and therefore Motorize and simplify said installations.

‘Gordian NODES’ that by virtue of their own are resolved and enhanced between the combination of their ‘Dual-BOX) 360 Bypass and simultaneous derivation’ with their ‘Extra & Fast)-dual Connectors’ and they Complemented with the ‘Dual PIPES’ and Remaining components for ‘Diversion, Control, etc., generate Magna-optimization in these Installations; and everything in ‘Materials and Joints/unions framework’ today market benchmarks and already established in the Installers.

Virtues by which this Innovative system ferociously Reduces (to ⅓ approx.) its Inter-connections and Decimates (up to 70%) the Times and labors consumed to the present by the already today Rudimentary simple double-laying; exponentiating Productivity in these works.

Conceived as an Integral and harmonious DUAL Piping System, which despite the ‘Unique type’ presented in this document as a conceptual/illustrative and non-limiting title of the same (according to ‘Section IV’) is also Per se Adequate and Feasible (manufacturable) with the General of Materials today worldwide referents for the aforementioned provision, and this via standard ‘Machines, Methods and Regulations’ (with only ‘Adaptation Investments’ and new Molds); extensible virtue to their Union systems- or Joints, since they can also be supported in the same format: be they by Thermo/electro-fusion, Cemented and/or Welded, Instantaneous (O-ring Seal) . . . and even Threaded Joints, as valid the final ‘FIG. 11’.

Qualities that to this Innovative system, allow it by a rope to ‘Couple or Intercalate’ to the general of existing pipes at present; and on the other, it can be ‘Scaled’ in diameter or ‘Expanded’ to transport other fluids, with the sole limitation of the ‘Material and joints’ in which it is adopted to manufacture.

Conclusion: All virtues in full benefit of (i) the ‘Productivity’ of the Installers, since it also reduces the ‘Handling of materials and their Stock’ on site; and for exclusivity (ii) the “Commercial Margin” of the manufacturer. Which constitutes the Innovative DUAL Piping System in “Optimal and natural replacement” of the today Rudimentary “Double laying” independent.

### IV. ‘BASE/Initials’ COMPONENTS OF THE INVENTION

DISCLAIMER: The DUAL Piping System is ‘Illustrated and exemplified’ (Section VII) in this document for the sole title ‘Conceptual/illustrative’ and without limitation of the same, in only 1 type (among its possible manufacturing range) modeled in tune with the traditional ones today, on ‘Standard Diagrams’ in Polypropylene to Thermo-fusion joints (PP/PP-Random in Ø=½″) among the world references for ‘Hot and cold water’ installations in buildings, with the which are then exemplified in their possible Use. And they always have their own identity, components with firm connections and calibrated Equidistance (according to the manufacturer's technical criteria) with guaranteed thermal imperturbability.

Except for this, the Base/initial List of Components of the brand new ‘DUAL Piping System’ is presented, which conceptually could be framed in:

### a) ‘Dual-Box) 360 of Cross-Over and Simultaneous Derivation’

The DUAL Piping System constitutes its ‘Most Disruptive and Enhancer Component (x5)’, in full accordance with the prescriptions of ‘Section III’ and previous explanation, it is Conceived in this exclusive ‘DUAL design’ of Technical resolution (FIG. 1) in pursuit of an ‘Intermediate Derivation/Branch’ of the Pair of pipes (in the same plane and Thickness) with its Hydraulic Bypass and harmoniously resolved internally ‘Via crushed with widening’ of both pipes (without affecting flow/see Hydraulic Resolution) in ‘Innovative response and excellent characteristic’ of this system . . . . And Motorized in the set on premise of its ‘Dual operability’ dynamics between parts. It is also worth noting its Multiple and universal positioning (for Exit towards ‘Up or down’) at the Installer's choice or project requirement.

Always Technically and judiciously in the ‘Dual-Box) 360’, depending on the Model and the Material adopted to be manufactured, its internal ‘Thickness S’ (minimum) and its Typology must be determined, as shown in Sections ‘A-A’ and ‘C-C’, of said figure and in its their Bypass area, in order to ensure the ‘thermal imperturbability’ between the fluids conveyed.

It is presented here with ‘Socket’ ends and in 2 initial formats:
The Dual-BOX) 360 of Cross-over and 2ble.derivation (FIG. 1a): in the exclusiveness of the detailed format, it masterfully solves the derivation of both ‘Pair pipes simultaneously, and it can be positioned in another sublime double-option of ‘Exit’ Left or right.
The Dual-BOX) 360 of Simple Cross-over (FIG. 1b): in the same exclusive format, here Solves the ‘Reverse Derivation’ of a single pipe of the pair.

### b) ‘Extra) Dual-Connectors’ Outside of Pipe Layout

Consolidating the brand new DUAL Piping System, they are components ‘also Enhancers (x4)’ in full accordance with the prescriptions of ‘Section III’ and previous explanation, Conceived in this exclusive ‘DUAL design’ of Technical resolution and Here in tune with the today traditional (Figure-2) in pursuit of Facing ‘outside the Layout’ of the pipes, in general of the External connections, be they outside the wall devices) as well as Intra-walls (Command panels) . . . . Always Motorized in the whole on the premise of its ‘Dual operability’ dynamics between parts.
Usually they have “Male ends” for Interconnection and “Threaded Outlets” for their external connection (Female or Male—and in general metallic) at the option of the Installer and/or project requirements . . . . Both are presented here with Separation of ‘Dc’ connection elastically adjustable by shape and lengths ‘L’ at the discretion of the manufacturer, in order to easy adjustment on site; and in 2 initial formats:
The Extra-PIPE) Dual-Thread for connections (FIG. 2-a) Solve the aforementioned ‘Double connections’ here external to the wall.
The Extra-TUBE) Dual-Thread for connections (FIG. 2-b) They also solve said ‘Double connections’ but now Intra-walls.

### c) ‘Fast) Dual-Connectors’ on Pipe Layout

Along the same lines as the Innovative DUAL Piping System, there are components ‘also Enhancers (×4)’ in full accordance with the prescriptions of ‘Section III’ and previous explanation, conceived in this exclusive ‘DUAL design’ of Technical resolution and Here in tune to today's traditional ones (Figure-3) in order to Face here ‘On the route’ of the pipes, to the general of the External connections out the wall . . . . Always Motorized in the set on the premise of its ‘Dual operability’ dynamics between parts.

Usually with double ends “Socket” for Inter-connection and “Threaded Outlets” for external connection (Female or Male—and generally metallic—at the option of the Installer or project requirement . . . . They are presented here in 3 initial formats:
The Dual) Thread-Connector (FIG. 3a) Solve the ‘Double-connections external to the wall’ here in the Intermediate Section of the Laying and covering the options of Threaded Outlet ‘Upper/Right or Left’ at the option of the Installer.
The Dual) Thread-Terminals (FIG. 3b) also solve the ‘Double-connections external out the wall’ but here in the last section of the Line and covering the same options ‘Top/Right or Left’ Threaded Outlet at the Installer's option.
The Dual) Thread-Simple (FIG. 3c) Solve the ‘Simple connection (a single pipe) and external out the wall’ in the Intermediate section of the Line, and also Threaded Outlet.

### d) ‘Dual-Components’ of Conduction/Derivation/Deviation and Others

d1-‘Dual-Pipes’

Is in the DUAL Piping System your ‘Basic component’, in full accordance with the prescriptions of ‘Section III’ and previous explanatory, conceived in this exclusive ‘DUAL design’ of Technical resolution and Here in tune with today's traditional (FIG. 4) are made up of a “Pair of pipes” equidistant, usually with ‘Male ends’ and it preferably manufactured in a single operation, they are twinned by an ‘Semi-continuous intermediate element’ of whole (guarantors of their rigidity and equidistance) designed according to the manufacturer's criteria, in pursuit of their ‘Compatibility and thermal imperturbability’, always depending on the Material (and joints) adopted in their manufacture . . . . They ‘Motorizables’ in the set on the premise of its dynamics of ‘Dual operability’ between parts.

When used (once the length of the section has been determined) they will always require ‘Freeing themselves from said joint framework’ at their ends and adapting them correctly, in order to ensure a reliable Dual-Assembly/connection.

d2—Dual ‘Derivations’

Components of the DUAL Piping System, fully in line with the prescriptions of ‘Section III’ and previous clarification, Conceived in this exclusive ‘DUAL design’ of Technical resolution and Here in tune with today's traditional ones (FIG. 5) in pursuit of Facing the general of the spatial derivations of Both (without surpassing) or only a Single pipe of the pair . . . and Motorized in the set on premise of its dynamics of ‘Dual operability’ between parts.

Usually Interconnect by ‘Socket/Socket’ ends . . . . Presented here in 3 initial formats:
The DOUBLE) TEE-Dual (FIG. 5a) Solves the double derivation in a direct and simultaneous way of the Pair of ‘Dual-pipe’ both in an orthogonal sense to it, such as being Another face of the wall.
The TEE) Dual-flat (FIG. 5b) Solves the individual derivation of a single pipe of the ‘Pair-Dual’ in a direct way (in its plane) upwards or downwards depending on its position, such as the feeding of toilets or Other Simple provisioning Artifacts.
TEE) Dual-Orthogonal (FIG. 5c) Solves the orthogonal derivation of ‘A pipe-pair’.
   d3-Dual ‘Deviations’

Components of the DUAL Piping System, in full accordance with the prescriptions of ‘Section III’ and previous clarification, Conceived in this exclusive ‘DUAL design’ of Technical resolution and Here in tune with today's traditional ones (FIG. 6) in pursuit of Facing the general of the spatial deviations and the simultaneous ‘Pair’ of pipes . . . . They Motorized in the whole on the premise of their dynamics of ‘Dual operability’ between parts.

Usually they of Inter-connection ‘Socket ends’ . . . . They are presented here in 2 initial formats:
The CURVE/ELBOW-Dual flat (FIGS. ‘6a and b’) allow the deviation of the ‘Dual Pipe’ in a specified Angle (usually at 45° and) 90° and in its same plane.
The CURVE/ELBOW-Dual of Corner (FIGS. ‘6c and d’) allow the deviation of the ‘Dual Pipe’ at a specified Angle (usually at 45° and) 90° but Breaks at the same.
   d4-Various ‘Dual-Fittings’

They are Components of the DUAL Piping System, fully in line with the prescriptions of ‘Section III’ and previous explanation, Conceived in this exclusive ‘DUAL design’ of Technical resolution and Here in tune with today's traditional ones (Figure-7) in pursuit of Facing various solutions for this Innovative system on its layout . . . . All Motorized in the set on the premise of its ‘Dual operability’ dynamics between parts.

They are presented here in 4 possible initial formats:
The Simple Dual-SOCKET (FIG. 7a) of ‘Female/Female’ ends Solves the splice between consecutive ‘Dual-Pipes’.
The SOCKET) Thread-dual (FIG. 7b): They face the Dual interconnected on one end on its layout and on the other they allow ‘Connection’ externally Via thread to other Systems . . . . Usually ‘Plug’ ends of inter-connection and ‘PIPES-Thread Output’ (Male or Female) at Option/requirement of the work.
The Dual CROSS-Over (FIG. 7c) are with ‘Male and/or Female’ ends, they allow facing Interferences in their plane with the standard Bypass of the ‘Dual-Pipes’.
The END Cup/Stopper-dual (FIG. 7d) of connection ends ‘Female (end-cup)/Male (stopper)’, are foreseen as Simple ‘Pair’ blocking of some end.
   d5-Dual ‘Glove/Ball-Valves’

Control's components of the DUAL Piping System, fully in line with the prescriptions of ‘Section III’ and previous Explanation, Conceived in this exclusive ‘DUAL design’ of Technical Resolution and Here in tune with today's traditional ones (FIG. 8) They are a Dual ‘GLOVE/BALL-Valves’ (of any type) in order to ‘Regulate/close’ the flow in the layout of these Installations . . . . Always Motorized in the set on the premise of its ‘Dual operability’ dynamics between parts; In general, they are ‘Male/Female Socket’ connections in order to be located where the Technician or the installation requires them.

### e) Specific ‘Dual-Tooling’:

Component of the DUAL Piping System, in full accordance with the prescriptions of ‘Section III’ and previous clarification, Conceived in this exclusive ‘DUAL design’ of Technical resolution and Here in tune with today's traditional ones (FIG. 9) ensuring the ‘double-Connections’ in calibrated Equidistance, crowns the System exemplified in this document and ‘Only valid for Thermo-plastic materials (PP/PP-R-among others) to Joint/union by Thermo-fusion’, a possible ‘Equipment is presented Thermo-Welding Machine with dual-Nozzles’ mounted, as ‘Motor AXIS’ of the Inter-connection of the assembly on the premise of its dynamics of ‘Dual operability’ between parts.

It is worth reiterating that the remaining connections to be chosen in the manufacture of this Innovative system will always be based on the ‘Material and joints’ adopted and in its Standard mode.

### f) ‘New Components:

Likewise, the previously detailed DUAL Piping System may be enriched (in line with the prescriptions of ‘Section III’ above) according to the technical-commercial criteria of the manufacturer, through: (i) ‘New ‘Fittings/accessories-dual’ in order to Complement the Base alternatives presented here; as well as (ii) with New ‘Dual-Tooling’ such as ‘Clamping and/or Cutting Pliers’, among multiple possibilities . . . . Always within the Framework of ‘Operability and DUAL-Assembly/connection’ typical of this System; And therefore, they will be understood as ‘fully included’ in it.

### Example of Standard Use:

Consolidating the above, it is exemplified as an illustrative title (and without limitation) of the Innovative DUAL Piping System, a typical section of ‘double-water distribution’: hot and cold.

In this way, the denounced ‘Gordian NODES’ are Sketched (FIG. 10a) on the current Rudimentary double-pipes lines, in 2 of the traumatic ‘Double-connection Zones’ (with and without Bypass) towards external Sanitary devices. Where it is worth reiterating that Usually these ‘Curious Multi-connections’ must be carried out in intra-wall gutters and uncomfortable Sectors.

And then, the ‘DUAL Piping System’ is illustrated (FIG. 10b) as it contrasts fiercely in ‘Productivity and aesthetics’ on the same performance, with its Masterful ‘Dual-BOX) 360 of surpassing’ combined with the ‘FAST) Connectors’ . . . . That consolidate it in ‘Optimal and natural’ replacement.

In Corollary: the ‘DUAL Piping System’, clears the already outdated of the Technique (or Art) to the present! . . . and focuses as in its DUAL design: It reduces to ⅓ the Inter-connections and Decimates 70% the Times and labors consumed, and therefore the Stock of materials in work. And also as its ‘Uniform Aesthetics’ invites to be Placed on walls.

### V. BRIEF DESCRIPTION OF THE DRAWINGS

(All in full accordance with the ‘Initial DISCLAIMER of Section IV’)

FIG. 1: It briefly/conceptually illustrates the Master ‘Dual-BOX) 360 of Cross-over and derivation’, according to ‘Section III-a’ in a possible Manufacturing model. Here raised type ‘Socket’ Inter-connection; They are sketched in ‘Perspective, Section and various Views’ and in 2 initial formats:
FIG. 1a: ‘Dual-BOX) 360 of Cross-over and simultaneous 2ble.derivation’.
FIG. 1b: ‘Dual-BOX) 360 of simple Cross-over.

In its Perspectives the simultaneous ‘Double Plumbing-Assembly/connection’ can be appreciated, as well as ‘Its Multiple options’ for positioning. The central ‘Detail 1-2’, sketches its sublime technical resolution of ‘Over-step between the Pair’ of pipes (in its plane and Thickness). illustrating the Hydraulic effect ‘Without affecting flow’ Via crushing and widening of both sections in Innovative own design. The ‘Cuts AA and C-C’ identify the Thickness ‘S’ of thermal imperturbability between ducts, to be determined according to the material in which it is manufactured.

FIG. 2: It briefly/conceptually illustrates the ‘EXTRA) Dual-Connectors’, according to ‘Section Ill-b’ in possible Manufacturing models. Here type ‘Male interconnection’ and Threaded outlet (Female), with Separation ‘Dc’ elastically adjustable and Length ‘L’ at the discretion of the manufacturer; They are sketched in ‘Perspective, Section and various Views’ and in 2 initial formats:
FIG. 2a: ‘Extra-PIPE) dual Thread’.
FIG. 2b: ‘Extra-TUBE) dual Thread’.

FIG. 3: It briefly/conceptually illustrates the ‘FAST) Dual-Connectors’, according to ‘Section III-c’ in a possible Manufacturing model. Here type ‘Female Inter-connection’ and Threaded Output (Female); They are sketched in ‘Perspective, Section and various Views’ and in 3 initial formats:
FIG. 3a: ‘DUAL) Thread-Connector’.
FIG. 3b: ‘DUAL) Thread-Terminal’.
FIG. 3c: ‘DUAL) Thread-Simple’.

FIG. 4: It briefly/conceptually illustrates the ‘Dual-PIPES’, according to ‘Section III-d. 1’ in a possible manufacturing Model. Here raised with both ends ‘Male’ and Twinned by an ‘Semi-continuous intermediate element’ of whole, in guarantee of the Plumb and dynamic ‘double Assembly/connection’ simultaneous typical of this Innovative system.

FIG. 5: It briefly/conceptually illustrates the ‘Dual-DERIVATIONS’, according to ‘Section III-d.2’ in a possible Manufacturing model. Here raised with type ‘Socket’ of Inter-connection; They are sketched in ‘Perspective, Section and various Views’ and in 3 initial formats:
FIG. 5a: The ‘DOUBLE) TEE-dual.
FIG. 5b: The ‘TEE) Dual-Flat’.
FIG. 5c: The ‘TEE) Dual-Orthogonal’.

FIG. 6: It briefly/conceptually illustrates the ‘Dual-DEVIATIONS’, according to ‘Section Ill-d.3’ in a possible Manufacturing model. Here raised with type ‘Plug’ of Inter-connection; They are sketched in ‘Perspective, Section and various Views’ and in 4 possible initial formats:
FIG. 6-′ay b′: ‘CURVES/ELBOW-dual flat’ at (a) 45° and at (b) 90° degrees.
FIG. 6-′cy d′: ‘CURVES/ELBOW-dual of corner’ at (c) 45° and at (d) 90° degrees.

FIG. 7: It briefly/conceptually illustrates the ‘FITTINGS’-various duals, according to ‘Section III-d.4’ in a possible Manufacturing model. They with their own Interconnection Types; They are sketched in ‘Perspective, Section and various Views’ and in 4 possible initial formats:
FIG. 7a: ‘Dual-SOCKET’ Simple, always Female ends.
FIG. 7b: ‘SOCKET) Thread-dual’, here end Socket and ‘Outlet-thread’ (female).
FIG. 7c: ‘Dual Cross-over’, here with both Male ends.
FIG. 7d: ‘End-cup’-dual, always Socket connections.

FIG. 8: It briefly/conceptually illustrates ‘Dual Glove/Ball-Valves’, according to ‘Section III-d5’ in a possible Manufacturing model. In Perspective here they are sketched in type ‘Socket’ of Inter-connection.

FIG. 9: It briefly/conceptually illustrates the special ‘Dual-Tooling’, according to ‘Section III-e’ in a possible Manufacturing model. In Perspective, here a possible Thermo-Welding Machine is sketched with its ‘Dual-Nozzles’ already assembled, as a brand new Motorizer of ‘Thermo-plastic Material systems’ (PP/PP-Random-among others) to Joint/union by Thermo-fusion, like the one exemplified here. On the right foot, its Use is conceptualized.

FIG. 10: It briefly/conceptually illustrates the ‘DUAL Piping System’ in its Use.
FIG. ‘10a’: He sketches and points out the aforementioned Gordian NODES on the now already ‘Rudimentary simple double-pipes’; in two of the current traumatic areas of 2ble-external connection.
FIG. ‘10b’: The disruptive ‘DUAL Piping System’ in fierce contrast on the same feature.

Which in corollary: It makes what is already Antiquated of the technique (or Art) transparent to the present; and Highlights the virtues of this Innovative system that make it its “Optimal and natural” replacement, and that also results in Layouts with their own Identity.

FIG. 11: The only feasibility of the ‘DUAL Piping System’ on Threaded Joints, conceptualizes the Dual-Assembly/connection via Sockets of ‘double ½-Inverted Thread’, forcing Dual-pipes ‘Standard thread’ with Fitting/accessories-dual ‘Inverted-Threaded males’.

1. ‘DUAL Piping System’ characterized by Solving the Assembly/connection of a ‘Pair of pipes’ operating as if it were only One, and this by means of ‘Plumbed and secured’ maneuvers; Suitable Per se for ‘Internal Installations’ of Tandem distribution of ‘Hot and cold water’ in buildings. Innovative dynamism resulting from this Innovative system with disruptive Dual-design (consisting of dual ‘Fittings/accessories and Pipes’) that in their own Identity, are twinned by joint-frameworks of ‘Semi-continuous lattice’ that ensure sufficient Rigidity and Calibrated equidistance (between ducts) with Thermal imperturbability, all in guarantee of their exclusive ‘Plumb and Dual’ Inter-connectability between components; Latticed that until normalized, will be at the manufacturer's criteria. This for the benefit of the ‘Promptness’ of these works, as well as their ‘Aesthetics’ invites them to be installed On-walls.

2. ‘DUAL Piping System’ in full accordance with claim #1, further characterized in the previously detailed and same Dual-operative provision, by ‘Atomizing the double-supply’ of sanitary devices to Only 2 or 3 Joints/assemblies maximum, by means of Masterful ‘dual-Components’ designed for this purpose (and Claimed below) that unravel in their plane and Thickness' the traumatic ‘Gordian NODES’ (Multi-connected with or without crossings) generated by the typical ‘Double-pipe sections’ up to now individual in Quasi-parallel. Therefore, this Innovative system Reduces (to ⅓ approx.) its Inter-connections and Decimates (up to 70%) the Times and labors consumed′ to the present by said already Rudimentary double-laying. And therefore, they Motorize the ‘Productivity’ in these works and the ‘exclusivity’ of the manufacturer of the system.

3. ‘DUAL Piping System’ in full accordance with claims #1 and 2, characterized by being Conceived Per se also ‘Adequate/manufacturable and Scalable’, with the general of Materials that are world-reference today, and this via ‘Machines, Methods and Regulations’ standard (with only Minimum investments); extensible virtue to its ‘Joints/union systems’ given that they can be supported in the same format: be they by Thermo/electro-fusion, Cemented or Welded, Instant (O-ring Seal), and even Threaded joints. Qualities that in a ‘Technical framework already established in the market’, by a rope allow it to ‘Couple or Intercalate’ to the general of existing pipes; as well as for another ‘Scaling’ in diameter and/or ‘Expanding’ to transport other fluids, only limited by the ‘Material and joints’ in which it is adopted to manufacture it.
And this, despite the figures presented in this document for conceptual/illustrative purposes only and not limitative of this disruptive system, Modeled on ‘only 1 Type’ of its possible manufacturing range (′PP/PP-R joint by Thermo-fusion′ and Ø≈½″) among world benchmarks for ‘Hot and cold water’ installations in buildings.

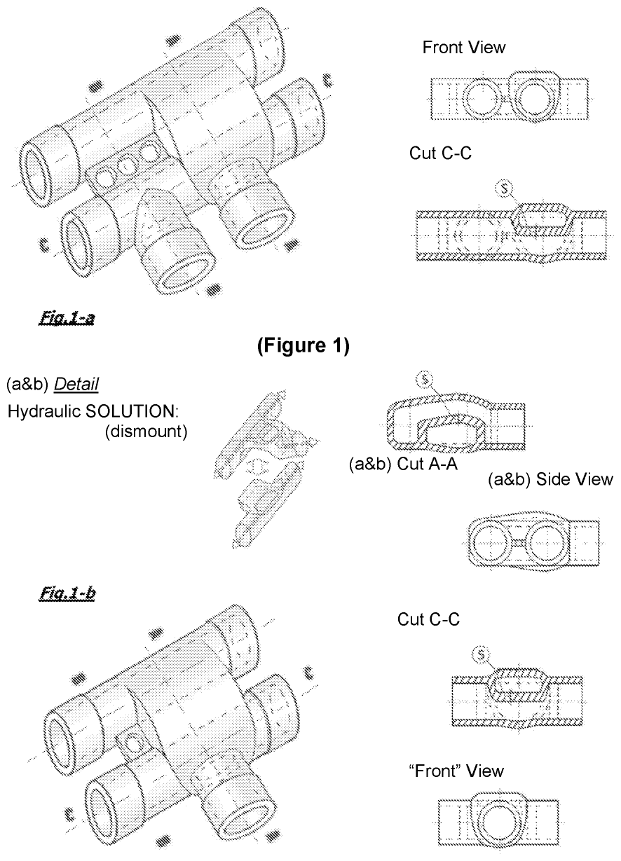

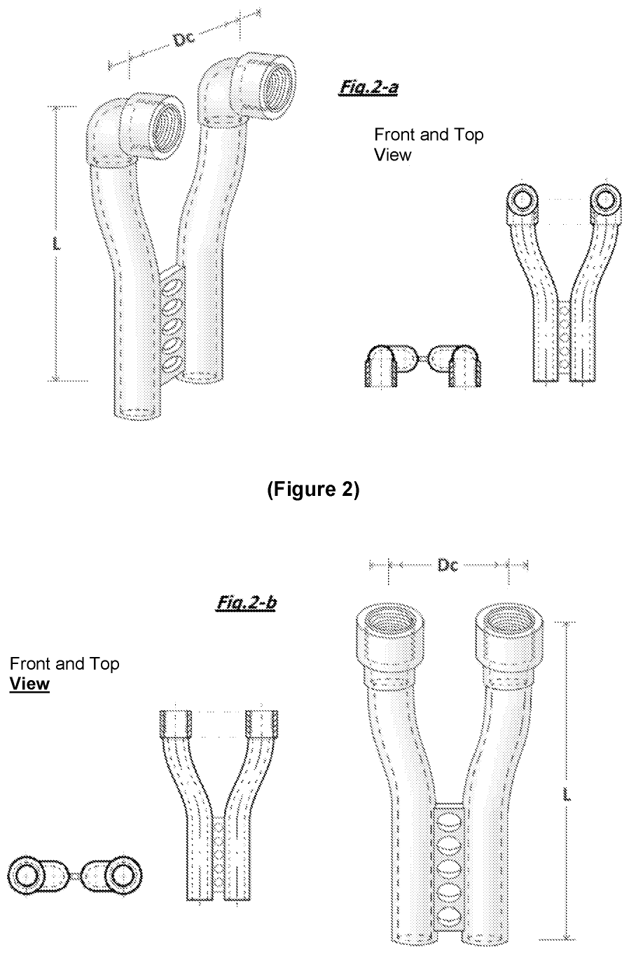

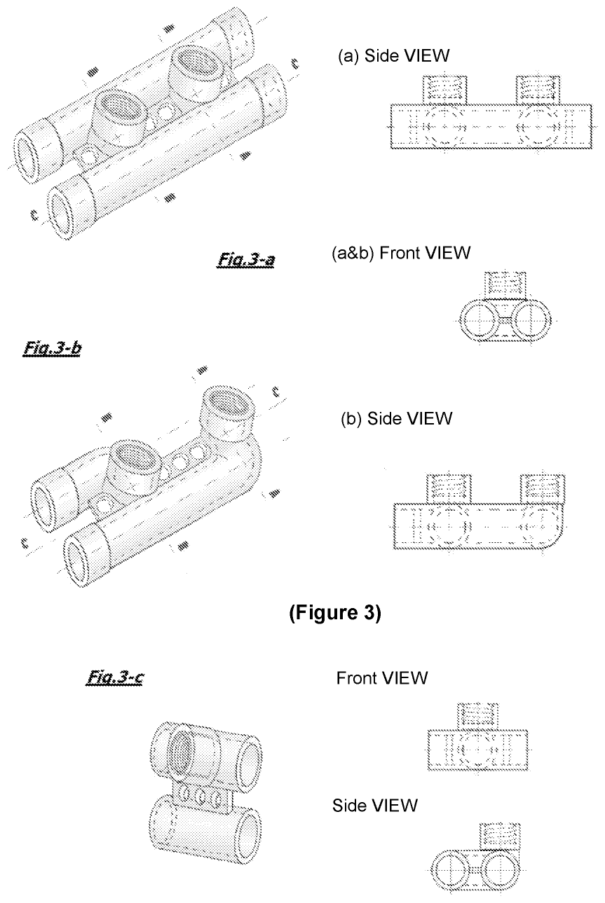

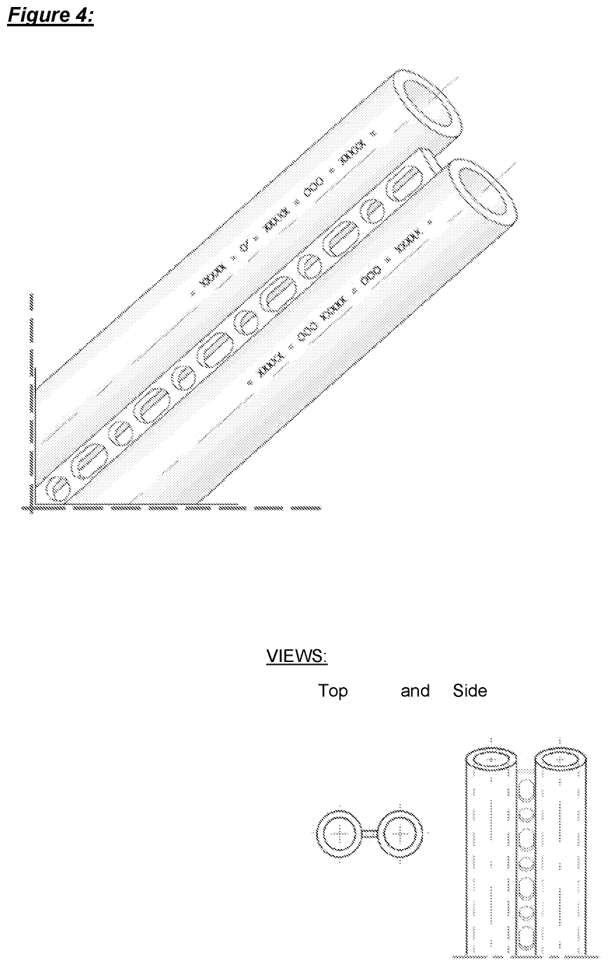

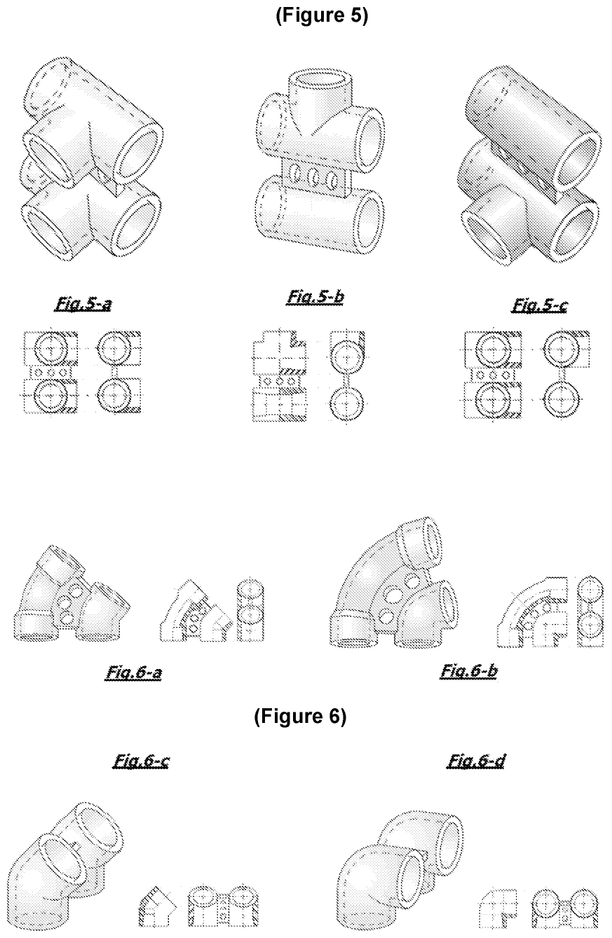

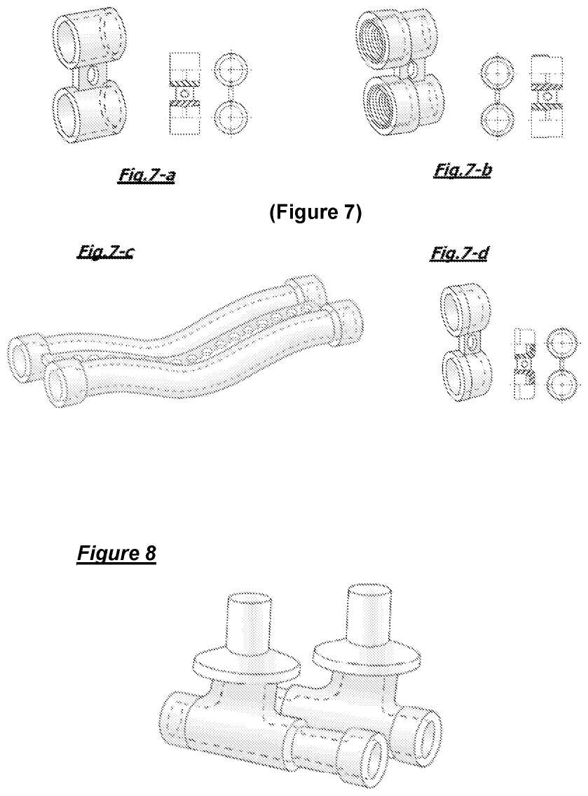

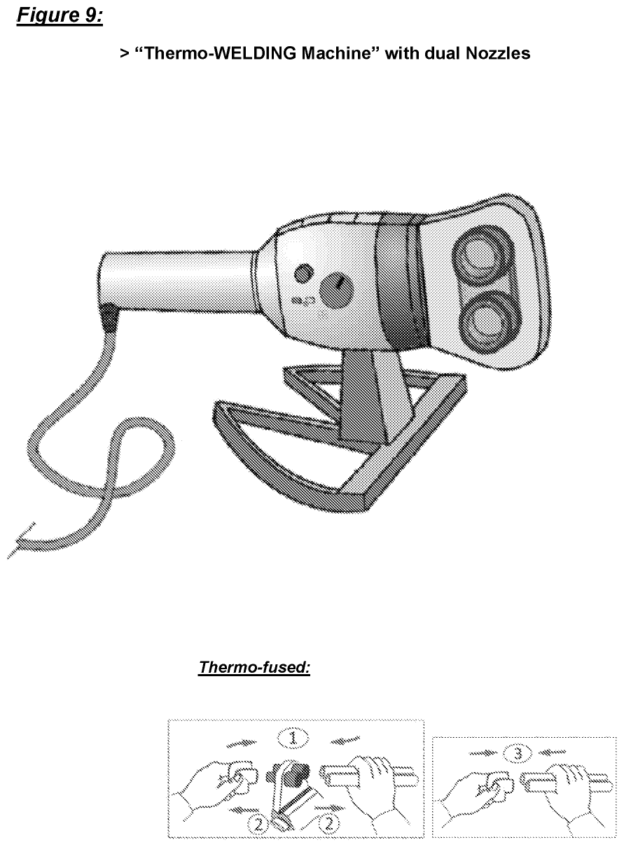

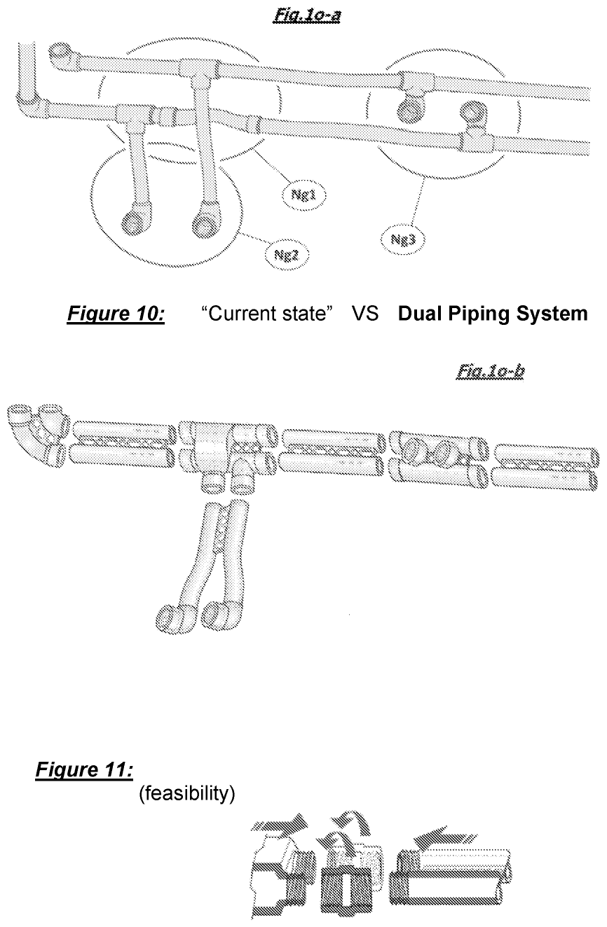

4. DUAL Piping System in full accordance with claims #1 to 3, further characterized by the ‘Dual-BOX) 360 of Cross-over and derivation’, its most disruptive and enhancing component (x5) conceived in this exclusive ‘DUAL design’ of Technical resolution (Figure-1) in pursuit of an ‘Intermediate Derivation/Branch’ of the Pair of pipes (in the same plane and Thickness) with its Hydraulic bypass and harmoniously resolved internally ‘Via flattened with widening’ of both pipes (without flow affectation) in ‘Innovative solution’ of this system; in them, depending on the Model and the Material adopted to be manufactured, determine their minimum ‘Thickness S’ and their Typology (see Sections ‘A-A’ and ‘C-C’) in their Bypass area, which ensures the ‘Thermal imperturbability’ between the conducted fluids. She Motorized in the set with premise of her dynamics of ‘Dual operability’ between parts; It must also be highlighted the Multiple and universal positioning of it (for Exit towards ‘Up or down’) at the choice of the Installer or project. It is presented here with ‘Socket’ ends and in 2 initial formats:
‘DUAL-Box) 360 of Cross-over and simultaneous 2ble.derivation’ (FIG. 1a) for Derivation of both ‘Pair-pipes’ simultaneously, and positionable to the left or right ‘Output’ option.
‘DUAL-Box) 360 of Simple Cross-over’ (FIG. 1b) for ‘Reverse branch’ of 1 pipe of the pair.

5. ‘DUAL Piping System’ in full accordance with claims #1 to 3, further characterized by its ‘EXTRA) Dual-Connectors’, components also Enhancers (x4) conceived in this exclusive ‘DUAL design’ of Technical Resolution and Here at in tune with today's traditional ones (FIG. 2) in pursuit of Facing ‘outside the Layout’ of the pipes, in general of the external Connections, be they outside the wall as well as Intra-walls. Always Motorized in the set with premise of its ‘Dual operability’ dynamics between parts. Usually of ‘Male ends’ of Inter-connection and ‘Threaded Outlets’ (Female or Male—and generally metallic-part) at the option of the Installer or project; they are presented here with elastically adjustable ‘connection spacing’ (by shape) and lengths at the discretion of the manufacturer, and in 2 initial formats:
‘Extra-PIPE) Dual-Threaded (FIG. 2a) for ‘Double connections’ external to the wall.
‘Extra-TUBE) Dual-Thread’ Dual (FIG. 2b) for ‘Double connections’ in the same Intra-wall.

6. ‘DUAL Piping System’ in full accordance with claims #1 to 3, further characterized by its ‘FAST) Dual-Connectors’ as well as Enhancer components (x4) conceived in this exclusive ‘DUAL design’ of Technical Resolution and Tuned Here to today's traditional ones (Figure-3) in pursuit of Facing here ‘About the layout’ of the pipes, to the general of Connections external to the wall. Always Motorized in the set with Premise of its dynamics of ‘Dual operability’ between parts. Usually ‘Socket ends’ for Inter-connection and ‘Threaded Outlets’ (Female or Male—and generally metallic-part) at the option of the Installer or project; They are presented here in 3 initial formats:
‘Dual) Thread-Connector’ (FIG. 3a) for ‘double-connection’ in the intermediate section.
‘Dual) Thread-Terminal’ (FIG. 3b) for ‘double-connections’ in the last section.
‘Dual) Thread’-Simple′ (FIG. 3c) for ‘Simple connection’ and Intermediate.

7. ‘DUAL Piping System’ fully consistent with claims #1 to 3, further characterized by its ‘Dual Components’ of Conduction/Derivation/Diversion/Control and others′, conceived in full of this Innovative system. And in ‘Initial base’ they are made up of:
i. The conduction ‘Dual PIPES’ are its basic component, conceived in this exclusive ‘DUAL design’ of technical resolution and here in tune with today's traditional ones (FIG. 4) made up of an equidistant ‘Pair of pipes’, usually of ‘Male ends’ and preferably manufactured in a single operation, they are twinned by an ‘Semi-continuous intermediate element’ of the whole (guarantors of their Rigidity and equidistance) designed according to the manufacturer's criteria, in pursuit of its ‘Thermal compatibility and imperturbability’, always depending on the material (and joints/union) adopted in its manufacture. Always ‘Motorizable’ in the set with the premise of its dynamics of ‘Dual operability’ between parts. In its use, its ends must always be ‘Freeing from its framework’ and adapted, in order to be correctly interconnected.
ii. The ‘DUAL-DERIVATIONS’, conceived in this exclusive ‘DUAL design’ of Technical resolution and Here in tune with today's traditional ones (FIG. 5) are components that Face the general of the spatial leads of Both (without exceeding) or a Single pipe of the pair; and always Motorized in the set with premise of its ‘Dual operability’ dynamics between parts. Usually interconnect by ‘Socket/socket’ ends, they are presented here in 3 initial formats:
‘DOUBLE) TEE’-Dual (FIG. 5a) for ‘double-derivation’ orthogonal to the Pair of pipes.
‘TEE) Dual-flat’ (FIG. 5b) for derivation of ‘Single Pair pipe’ and in its plane.
‘TEE) Dual-Orthogonal’ (FIG. 5c) for orthogonal derivation of ‘Single Pair pipe’.
iii. The ‘Dual DEVIATIONS’, conceived in this exclusive ‘DUAL design’ of Technical Resolution and Here in tune with today's traditional ones (FIG. 6) are components that Face the general of spatial deviations and simultaneously ‘of the Pair’ of pipes; and always Motorized in the set with Premise of its ‘Dual operability’ dynamics between parts. Usually of Inter-connection ‘Socket ends’, they are presented (at 45° and) 90° here in 2 initial formats:
‘CURVE/ELBOW-Dual flat’ (FIGS. 6a and b) for the deviation of the ‘Dual-pair’ in its same plane.
‘CURVE/ELBOW-Dual Corner’ (FIGS. 6c and d) for the deviation ‘of the Pair’ broken to it.
iv. Various ‘Dual-Fittings/accessories’, conceived in this exclusive ‘DUAL-design’ of Technical resolution and Here in tune with today's traditional ones (FIG. 7) are components that Face various solutions for this Innovative system on their layout; and always Motorized in the set with Premise of its ‘Dual operability’ dynamics between parts.—And They are presented here in 4 possible initial formats:
Simple ‘Dual-Socket’ (FIG. 7a) for Inter-connection between consecutive ‘Dual-pipes’ . . . ‘SOCKET) Thread-dual (FIG. 7b) to ‘Connect this system’ with ‘PIPE-Thread’ towards others.
The ‘Dual-Cross-over’ (FIG. 7c) allow the ‘Dual-Bypass’ of an interference.
The ‘End-cup/Stopper-dual’ (FIG. 7d) for ‘Torque’ locks in the installation, they are provided with a ‘Female (end-cup)/Male (stopper)’ connection.
v. ‘GLOVE/BALL VALVES-dual’, conceived in this exclusive ‘DUAL design’ of Technical resolution and Here in tune with today's traditional ones (FIG. 8), are components to ‘Regulate or close’ (in any type) the flow in the layout of these Installations, and always Motorized in the set with premise of its dynamics of ‘Dual operability’ between parts; In general, they are ‘Socket connections’ in order to be located where the Technician or the installation requires them.

8. ‘DUAL Piping System’ in full accordance with claims #1 to 3, further characterized by its exclusive ‘Dual-Tooling’ (and specific) conceived in this exclusive ‘DUAL-design’ of Technical resolution and Here in tune with today's traditional (FIG. 9), in pursuit of ensuring the ‘double-Connections’ in calibrated Equidistance: its ‘Dual-Nozzle Thermo-Welding Machine’ crowns the System exemplified here′, Only valid for Thermo-plastic Materials (PP/PP-R among others) to Joint/union by Thermo-fusion′, as ‘AXIS-Motor of the Inter-connection’ of the set in its Premise of ‘Dual operability dynamics’ between parts.

9. ‘DUAL Piping System’ in full accordance with claims #1 to 3, further characterized in that ‘Supplementary Rope’ may be Enriched according to the manufacturer's Technical-commercial criteria, through: (i) ‘New ‘Fittings/accessories-dual’ to in order to Complement the parts presented here, and (ii) with New ‘Dual-Tooling’ such as ‘Clamping and/or Cutting Pliers’, among other possibilities; always within the framework of ‘Operability and DUAL-Assembly/connection’ proper to this system. And therefore, they will be understood as ‘full comprehended’ in the same.
